(19) United States
(12) Patent Application Publication
(10) Pub. No.: US 2021/0045568 A1
(43) Pub. Date: Feb. 18, 2021

(54) Arepa Shaping Assembly

(71) Applicant: Maria Sabeh, Sugar Hill, GA (US)

(72) Inventor: Maria Sabeh, Sugar Hill, GA (US)

(21) Appl. No.: 16/538,633

(22) Filed: Aug. 12, 2019

(51) Int. Cl. A47J 27/00; A21C 11/00; A21B 5/00; H05B 3/42

(52) U.S. Cl. CPC A47J 27/004; H05B 3/42; A21B 5/00; A21C 11/00

(57) ABSTRACT

An arepa shaping assembly for cooking conical arepa includes a cooker that has a pair of cooking wells therein to receive arepa dough for cooking. Each of the cooking wells tapers to a point such that each of the cooking wells has a conical shape and the cooker is turned on to cook the arepa dough. A form is provided that has a pair of spikes thereon. Each of the spikes is inserted into a respective one of the cooking wells when the form is positioned on the cooker to form the arepa dough into a cone. Additionally, the form includes a heater for cooking the arepa dough.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to food shaping device and more particularly pertains to a new shaping device for cooking conical arepa.

### (2) Description of Related Art Including Information Disclosed Under 37 CFR 1.97 and 1.98

The prior art relates to food shaping devices.

### BRIEF SUMMARY OF THE INVENTION

An embodiment of the disclosure meets the needs presented above by generally comprising a cooker that has a pair of cooking wells therein to receive arepa dough for cooking. Each of the cooking wells tapers to a point such that each of the cooking wells has a conical shape and the cooker is turned on to cook the arepa dough. A form is provided that has a pair of spikes thereon. Each of the spikes is inserted into a respective one of the cooking wells when the form is positioned on the cooker to form the arepa dough into a cone. Additionally, the form includes a heater for cooking the arepa dough.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an exploded perspective view of an arepa shaping assembly according to an embodiment of the disclosure.

FIG. 2 is a front phantom view of a cooker of an embodiment of the disclosure.

FIG. 3 is an exploded back view of an embodiment of the disclosure.

FIG. 4 is a top view of an embodiment of the disclosure.

FIG. 5 is a cross sectional view taken along line 5-5 of FIG. 3 of an embodiment of the disclosure.

FIG. 6 is a bottom perspective view of a form of an embodiment of the disclosure.

FIG. 7 is a perspective view of an embodiment of the disclosure showing cooked arepa being removed from a cooker.

### DETAILED DESCRIPTION OF THE INVENTION

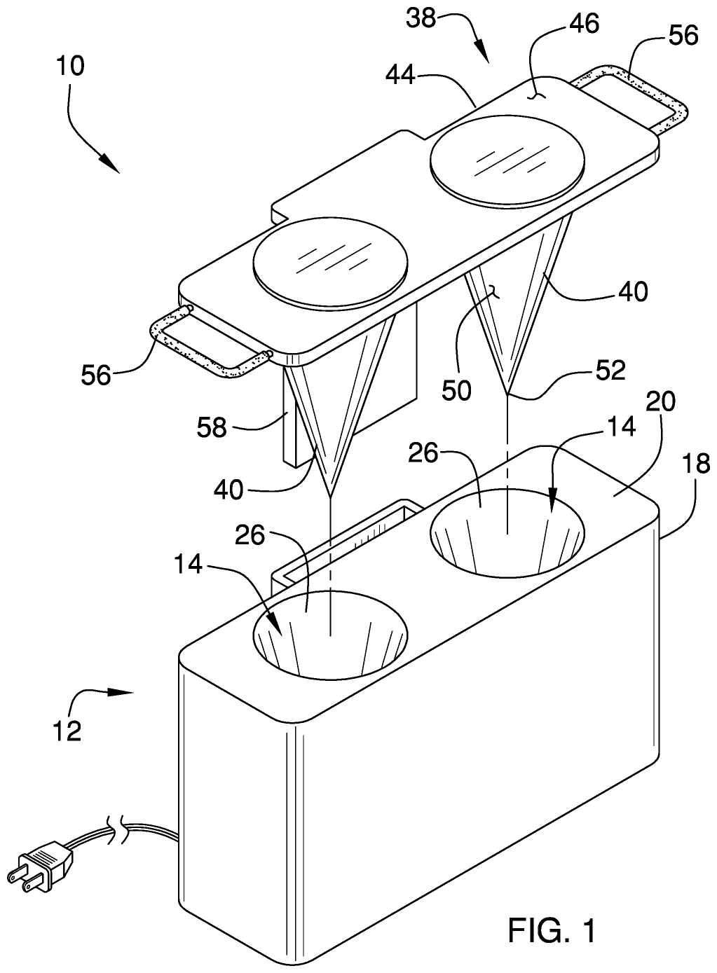

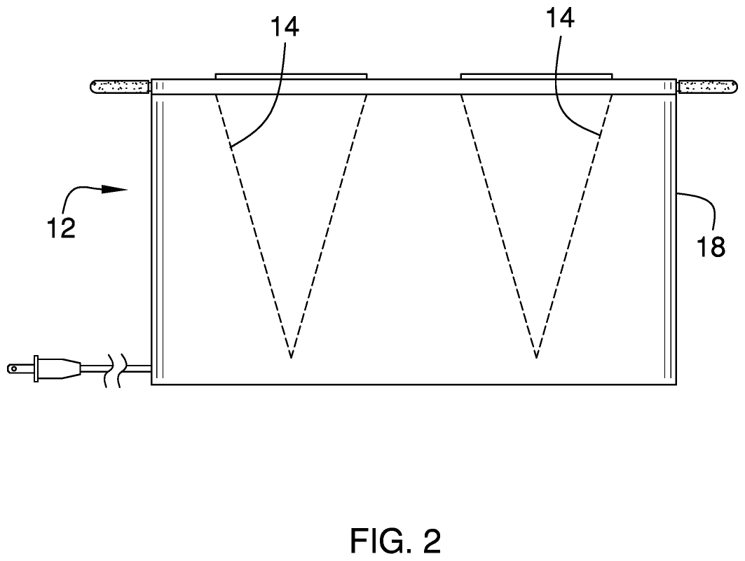

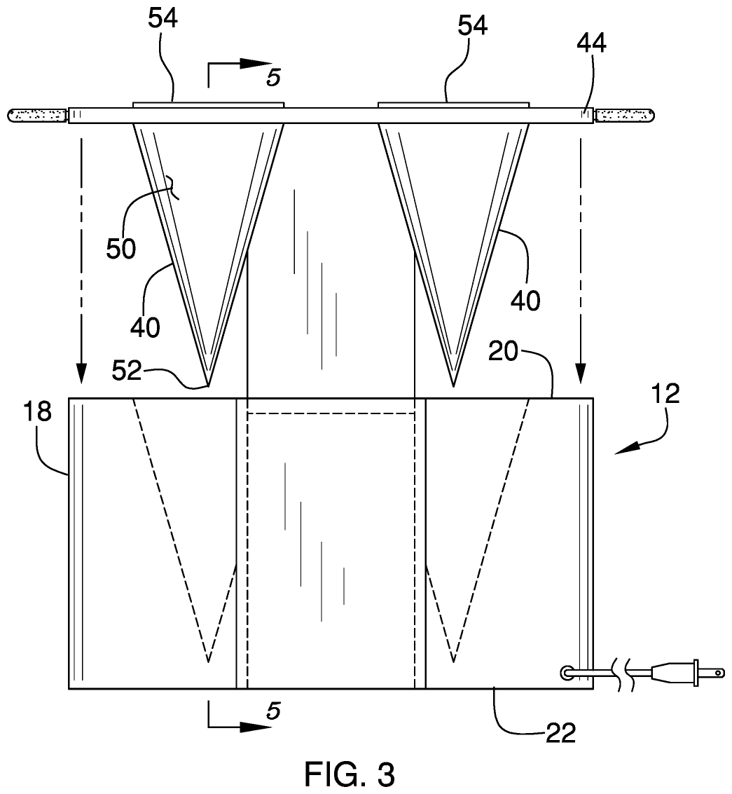

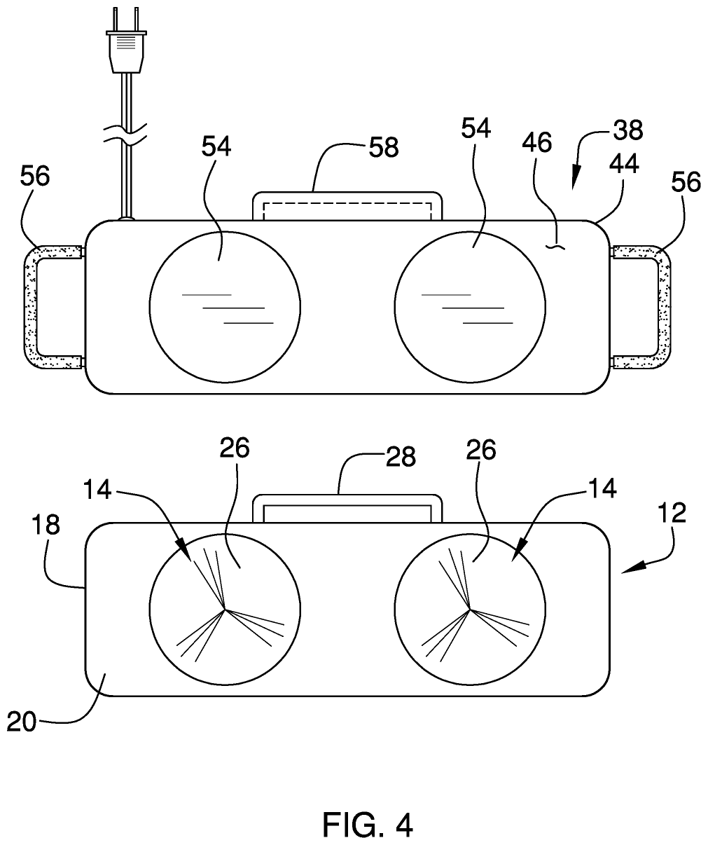

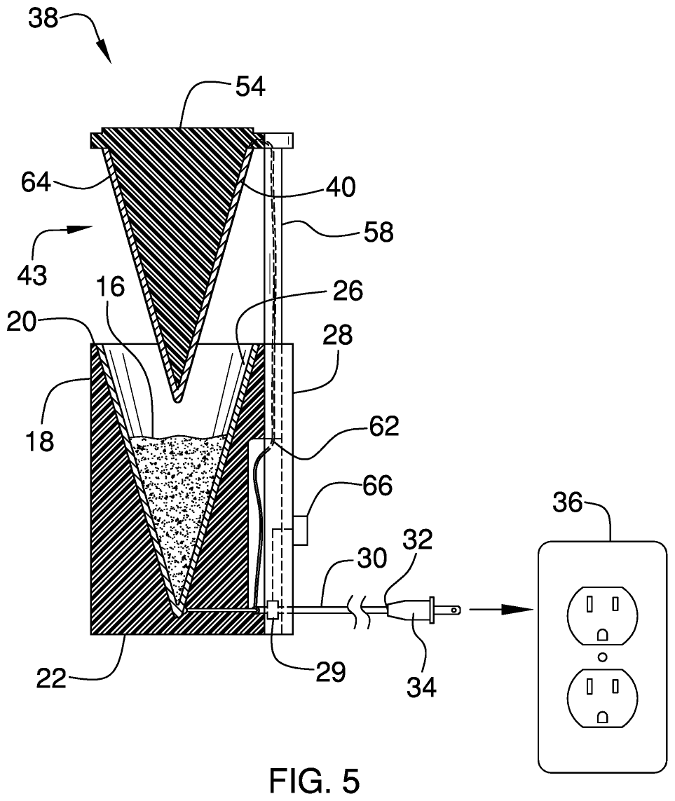

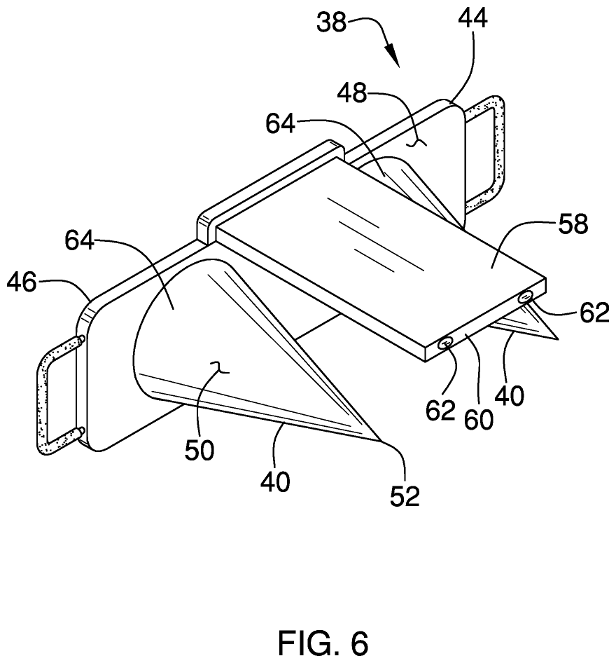

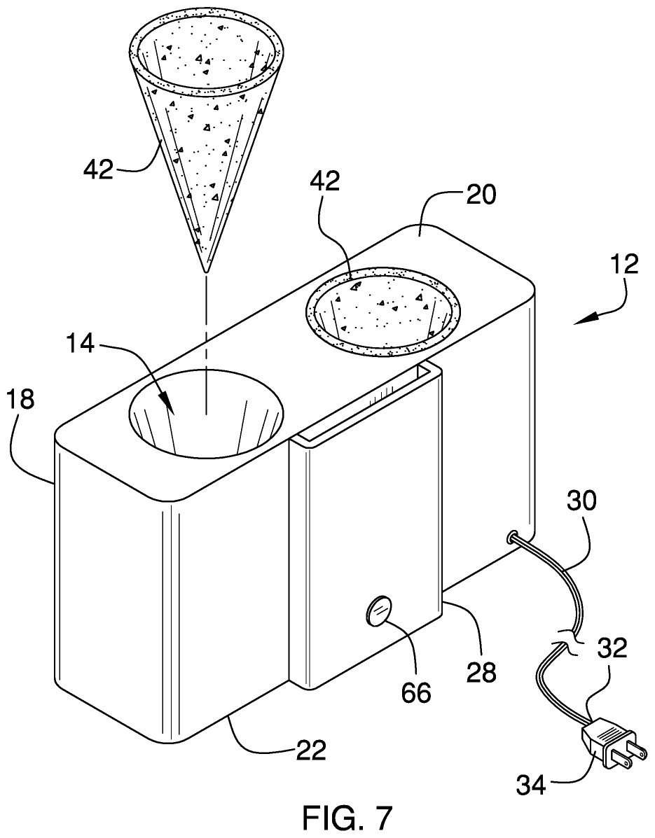

With reference now to the drawings, and in particular to FIGS. 1 through 7 thereof, a new shaping device embodying the principles and concepts of an embodiment of the disclosure and generally designated by the reference numeral 10 will be described.

As best illustrated in FIGS. 1 through 7, the arepa shaping assembly 10 generally comprises a cooker 12 that has a pair of cooking wells 14 therein to receive arepa dough 16 for cooking. Each of the cooking wells 14 tapers to a point such that each of the cooking wells 14 has a conical shape. Moreover, the cooker 12 is turned on to cook the arepa dough 16. The cooker 12 comprises a housing 18 that has a top wall 20, a bottom wall 22 and a back wall 24. Each of the cooking wells 14 extends through the top wall 20 toward the bottom wall 22, and each of the cooking wells 14 has a bounding surface 25.

The cooker 12 includes a pair of housing heating elements 26 and each of the housing heating elements 26 is positioned within the housing 18. Each of the housing heating elements 26 surrounds a respective one of the cooking wells 14. In this way each of the housing heating elements 26 is in thermal communication with the arepa dough 16 when the arepa dough 16 is poured into the cooking wells 14. Each of the housing heating elements 26 heats the arepa dough 16 when the housing heating elements 26 are turned on to cook the arepa dough 16. Each of the housing heating elements 26 may comprise an electric heating element with an operational temperature of at least 300.0 degrees Fahrenheit. Additionally, each of the housing heating elements 26 may be comprised of a non-stick material to inhibit the arepa dough 16 from sticking to the housing heating elements 26.

A receiver 28 is coupled to the back wall 24 of the housing 18. A plurality of receiver contacts 29 is each positioned within the receiver 28. Each of the receiver contacts 29 is comprised of an electrically conductive material. A power cord 30 is coupled to and extends away from the housing 18. The power cord 30 is electrically coupled to each of the housing heating elements 26 and the power cord 30 is electrically coupled to each of the receiver contacts 29. The power cord 30 has a distal end 32 with respect to the housing 18 and a male plug 34 is electrically coupled to the distal end 32. The male plug 34 can be electrically coupled to a power source 36 comprising a female electrical outlet.

A form 38 is provided and the form 38 has a pair of spikes 40 thereon. Each of the spikes 40 is inserted into a respective one of the cooking wells 14 when the form 38 is positioned on the cooker 12. In this way each of the spikes 40 forms the arepa dough 16 into a cone. In this way the cone formed by the cooked arepa 42 can be filled with various food items. Moreover, the form 38 includes a heater 43 for cooking the arepa dough 16.

The form 38 comprises a panel 44 that has a top surface 46 and a bottom surface 48, and each of the spikes 40 extends downwardly from the bottom surface 48. Each of the spikes 40 has an outer surface 50 and a distal end 52. The outer surface 50 of each of the spikes 40 tapers to a point at the distal end 52 such that each of the spikes 40 has a conical shape. The top surface 46 has a pair of prominences 54 extending upwardly therefrom and each of the prominences 54 is aligned with a respective one of the spikes 40. The bottom surface 48 of the panel 44 rests on the top wall 20 of the housing 18 when the form 38 is positioned on the housing 18.

A pair of handles 56 is provided and each of the handles 56 is coupled to opposite ends of the panel 44 for gripping. Each of the handles 56 is comprised of a thermally insulating material to inhibit a user from getting burned when the handles 56 are gripped. A tab 58 is coupled to and extends downwardly from the bottom surface 48 of the panel 44. The receiver 28 on the housing 18 insertably receives the tab 58 when the panel 44 is positioned on the housing 18 and the tab 58 has a bottom end 60.

A plurality of tab contacts 62 is each coupled to the bottom end of the tab 58. Each of the tab contacts 62 is comprised of an electrically conductive material. Each of the tab contacts 62 engages a respective one of the receiver contacts 29 when the tab 58 is inserted into the receiver 28. Thus, each of the tab contacts 62 is in electrical communication with the respective receiver 28 contact.

The heater 43 comprises a pair of spike heating elements 64. Each of the spike heating elements 64 surrounds the outer surface 50 of a respective one of the spikes 40. Each of the spike heating elements 64 is in thermal communication with the arepa dough 16 when the arepa dough 16 is poured into the cooking wells 14 and the panel 44 is positioned on the housing 18. Additionally, each of the spike heating elements 64 is electrically coupled to a respective one of the tab contacts 62.

Each of the spike heating elements 64 may comprise an electric heating element with an operational temperature of at least 300.0 degrees Fahrenheit. Additionally, each of the spike heating elements 64 may be comprised of a non-stick to inhibit the arepa dough 16 from sticking to the spike heating elements 64. A power button 66 is coupled to the housing 18 and the power button 66 is in electrical communication with each of the housing heating elements 26 and the spike heating elements 64 when the form 38 is positioned on the housing 18. The power button 66 turns on and off each of the housing heating elements 26 and the spike heating elements 64.

In use, the arepa dough 16 is poured into each of the cooking wells 14 in the housing 18. The form 38 is positioned on the housing 18 such that each of the spikes 40 is inserted into the respective cooking well. In this way the arepa dough 16 in each of the cooking wells 14 is formed into a cone. The power button 66 is manipulated to turn on each of the housing heating elements 26 and each of the spike heating elements 64. In this way the arepa dough 16 is cooked and retained in the cone. The form 38 is removed from the housing 18 after sufficient time has passed to cook the arepa dough 16 and the cooked arepa 42 cones are removed from each of the cooking wells 14. Each of the cooked arepa 42 cones can be filled with selected food items for eating.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An arepa shaping assembly being configured to shape and cook arepa into a conical shape, said assembly comprising:
a cooker having a pair of cooking wells therein wherein each of said cooking wells is configured to receive arepa dough for cooking, each of said cooking wells tapering to a point such that each of said cooking wells has a conical shape, said cooker being turned on to cook the arepa dough; and
a form having a pair of spikes thereon, each of said spikes being inserted into a respective one of said cooking wells when said form is positioned on said cooker wherein each of said spikes is configured to form the arepa dough into a cone, said form including a heater for cooking the arepa dough.

2. The assembly according to claim 1, wherein said cooker comprises a housing having a top wall, a bottom wall and a back wall, each of said cooking wells extending through said top wall toward said bottom wall, each of said cooking wells having a bounding surface.

3. The assembly according to claim 2, wherein said cooker comprises a pair of housing heating elements, each of said housing heating elements being positioned within said housing, each of said housing heating elements surrounding a respective one of said cooking wells wherein each of said housing heating elements is configured to be in thermal communication with the arepa dough when the arepa dough is poured into said cooking wells, each of said housing heating elements heating the arepa dough when said housing heating elements are turned on.

4. The assembly according to claim 3, wherein said cooker includes a receiver being coupled to said back wall of said housing.

5. The assembly according to claim 4, wherein said cooker includes a plurality of receiver contacts, each of said receiver contacts being positioned within said receiver, each of said receiver contacts being comprised of an electrically conductive material.

6. The assembly according to claim 5, wherein said cooker includes a power cord being coupled to and extending away from said housing, said power cord being electrically coupled to each of said housing heating elements, said power cord being electrically coupled to each of said receiver contacts, said power cord having a distal end with respect to said housing, said distal end having a male plug being electrically coupled thereto wherein said male plug is configured to be electrically coupled to a power source comprising a female electrical outlet.

7. The assembly according to claim 5, wherein said form comprises a panel having a top surface and a bottom surface, each of said spikes extending downwardly from said bottom surface, each of said spikes having an outer surface and a distal end, said outer surface of each of said spikes tapering to a point at said distal end such that each of said spikes has a conical shape, said top surface having a pair of prominences extending upwardly therefrom, each of said prominences being aligned with a respective one of said spikes, said bottom surface of said panel resting on said top wall of said housing when said form is positioned on said housing.

8. The assembly according to claim 7, further comprising a pair of handles, each of said handles being coupled to opposite ends of said panel wherein each of said handles is configured to be gripped, each of said handles being comprised of a thermally insulating material wherein each of said handles is configured to inhibit a user from getting burned when said handles are gripped.

9. The assembly according to claim 7, further comprising a tab being coupled to and extending downwardly from said bottom surface of said panel, said receiver on said housing insertably receiving said tab when said panel is positioned on said housing, said tab having a bottom end.

10. The assembly according to claim 9, further comprising a plurality of tab contacts, each of said tab contacts being coupled to said bottom end of said tab, each of said tab contacts being comprised of an electrically conductive material, each of said tab contacts engaging a respective one of said receiver contacts when said tab is inserted into said receiver such that each of said tab contacts is in electrical communication with said respective receiver contact.

11. The assembly according to claim 10, wherein said heater comprises a pair of spike heating elements, each of said spike heating elements surrounding said outer surface of a respective one of said spikes wherein each of said spike heating elements is configured to be in thermal communication with the arepa dough when the arepa dough is poured into said cooking wells and said panel is positioned on said housing, each of said spike heating elements being electrically coupled to a respective one of said tab contacts.

12. An arepa shaping assembly being configured to shape and cook arepa into a conical shape, said assembly comprising:
a cooker having a pair of cooking wells therein wherein each of said cooking wells is configured to receive arepa dough for cooking, each of said cooking wells tapering to a point such that each of said cooking wells has a conical shape, said cooker being turned on to cook the arepa dough, said cooker comprising:
a housing having a top wall, a bottom wall and a back wall, each of said cooking wells extending through said top wall toward said bottom wall, each of said cooking wells having a bounding surface;
a pair of housing heating elements, each of said housing heating elements being positioned within said housing, each of said housing heating elements surrounding a respective one of said cooking wells wherein each of said housing heating elements is configured to be in thermal communication with the arepa dough when the arepa dough is poured into said cooking wells, each of said housing heating elements heating the arepa dough when said housing heating elements are turned on;
a receiver being coupled to said back wall of said housing;
a plurality of receiver contacts, each of said receiver contacts being positioned within said receiver, each of said receiver contacts being comprised of an electrically conductive material; and
a power cord being coupled to and extending away from said housing, said power cord being electrically coupled to each of said housing heating elements, said power cord being electrically coupled to each of said receiver contacts, said power cord having a distal end with respect to said housing, said distal end having a male plug being electrically coupled thereto wherein said male plug is configured to be electrically coupled to a power source comprising a female electrical outlet;
a form having a pair of spikes thereon, each of said spikes being inserted into a respective one of said cooking wells when said form is positioned on said cooker wherein each of said spikes is configured to form the arepa dough into a cone, said form including a heater for cooking the arepa dough, said form comprising:
a panel having a top surface and a bottom surface, each of said spikes extending downwardly from said bottom surface, each of said spikes having an outer surface and a distal end, said outer surface of each of said spikes tapering to a point at said distal end such that each of said spikes has a conical shape, said top surface having a pair of prominences extending upwardly therefrom, each of said prominences being aligned with a respective one of said spikes, said bottom surface of said panel resting on said top wall of said housing when said form is positioned on said housing;
a pair of handles, each of said handles being coupled to opposite ends of said panel wherein each of said handles is configured to be gripped, each of said handles being comprised of a thermally insulating material wherein each of said handles is configured to inhibit a user from getting burned when said handles are gripped;
a tab being coupled to and extending downwardly from said bottom surface of said panel, said receiver on said housing insertably receiving said tab when said panel is positioned on said housing, said tab having a bottom end;
a plurality of tab contacts, each of said tab contacts being coupled to said bottom end of said tab, each of said tab contacts being comprised of an electrically conductive material, each of said tab contacts engaging a respective one of said receiver contacts when said tab is inserted into said receiver such that each of said tab contacts is in electrical communication with said respective receiver contact; and
said heater comprises a pair of spike heating elements, each of said spike heating elements surrounding said outer surface of a respective one of said spikes wherein each of said spike heating elements is configured to be in thermal communication with the arepa dough when the arepa dough is poured into said cooking wells and said panel is positioned on said housing, each of said spike heating elements being electrically coupled to a respective one of said tab contacts.
